(19) United States
(12) Patent Application Publication
(10) Pub. No.: US 2026/0134854 A1
(43) Pub. Date: May 14, 2026

(54) HARMONICA STAND ASSEMBLIES HAVING HEIGHT-ADJUSTABLE HARMONICA HOLDERS

(71) Applicant: Steven J. Spivey, Westport, MA (US)

(72) Inventor: Steven J. Spivey, Westport, MA (US)

(21) Appl. No.: 19/389,625

(22) Filed: Nov. 14, 2025

Related U.S. Application Data
(60) Provisional application No. 63/720,408, filed on Nov. 14, 2024.

(51) Int. Cl. G10G 5/00; F16M 11/10; F16M 11/18; F16M 13/02

(52) U.S. Cl. CPC G10G 5/005; F16M 11/10; F16M 11/18; F16M 13/022

(57) ABSTRACT

A harmonica stand assembly is provided. The harmonica stand assembly comprises an elongated, upright microphone stand; a frame having an upper portion and a lower portion, wherein a harmonica holder is positioned in the upper portion, and a foot pedal is positioned in the lower portion; and an actuator system. The harmonica stand assembly allows the harmonica player to move the harmonica to a precisely desired position. Preferably, the harmonica player can move the harmonica so that it sits at the same height as the microphone.

### CROSS-REFERENCE TO RELATED APPLICATIONS

The application claims the benefit of U.S. Provisional Patent Application No. 63/720,408 filed Nov. 14, 2024, the entire disclosure of which is hereby incorporated by reference.

### BACKGROUND OF THE INVENTION

### Field of the Invention

The present invention relates generally to harmonica stand assemblies for holding harmonicas. More particularly, the present invention relates to harmonica stand assemblies having height-adjustable harmonica holders that can be operated by a foot pedal. The height of the harmonica can be adjusted precisely with the harmonica stand assembly of the invention.

### Brief Review of the Related Art

Many harmonica players use harmonica holders when performing at a musical event. Harmonica players use such harmonica holders to keep their hands free while performing. In this way, the harmonica player can play another instrument such as, for example, a guitar or piano. Harmonica players generally prefer using such hand-free harmonica holders because they feel more comfortable. With such hand-free harmonica holders, the harmonica player can stand while playing the harmonica, sit on a stool, or even move around the stage or audience.

Some harmonica holders are referred to as harness-type harmonica holders. For example, H. Ernest, U.S. Pat. No. 3,172,328 discloses a harness-type holder for harmonicas, wherein the holder is characterized by spring-biased mounting and clamping members which are constructed to grip and hold harmonicas of various sizes. The elongated jaw-equipped spring-loaded harmonica clamping members on the inverted U-frame allows the frame to support small, medium, and large harmonicas. F. A. Pochobradsky, U.S. Pat. No. 3,332,310 discloses a harness-type holder having a neck embracing yoke and a complementary inverted U-shaped harmonica positioning and supporting frame. A plate in the holder is pressed against the springs until part of the harmonica can be inserted between the plate and other portion of the frame. After the parts have been adjusted, the springs will cause the plate to properly clamp the harmonica in place so that the harmonica player may play on the harmonica.

Other harmonica holders are mounted on a harmonica stand. For example, D. Hubbard, U.S. Pat. No. 4,212,219 discloses a holder for a harmonica comprising a pole mounted on a floor stand, a harmonica seat removably secured to the top of the pole and a pressure bar to releasably clamp a harmonica against the seat. The harmonica seat is releasably mounted at the top of the pole, and a spring-biased pressure bar clamps the harmonica in place on the seat. A microphone also is carried on the pole and is disposed immediately behind and below the harmonica. A plastic windshield is disposed between the harmonica and microphone with a small opening aligned with the harmonica.

Many musicians use height-adjustable microphone stands when performing on stage. When using such music stands, the musician normally sets the microphone stand at a specific height before he/she begins to perform. However, it can be difficult to perfectly match the height of the microphone stand with the corresponding instrument. For example, a harmonica player can set their microphone stand at calculated height before beginning to perform, The harmonica player also may use a conventional harmonica stand, but the harmonica still tends to rest under the microphone. When the harmonica and microphone are not properly aligned, there can be acoustic problems. The harmonica player often needs to adjust the height of the harmonica and/or microphone so that they are aligned. This adjusting of the harmonica and microphone can be cumbersome and time-consuming. The harmonica player and audience can get distracted by the constant fiddling of the equipment.

Thus, there is a need for a height-adjustable harmonica stand assembly that a harmonica player can easily handle. A harmonica player should be able to easily operate a harmonica stand assembly so that the harmonica is adjacent to and sits at the same height as the microphone. In this manner, the harmonica player can play the harmonica, and the adjacent microphone can accurately capture the sounds generated by the harmonica. In such a system, there would be no obstructions between the harmonica and microphone, and there would be better acoustics. The present invention provides such a harmonica stand assembly. Other advantages, features, and benefits of the present invention are described further below.

### SUMMARY OF THE INVENTION

The present generally relates to harmonica stand assemblies for holding harmonicas. More particularly, the present invention relates to harmonica stand assemblies having height-adjustable harmonica holders that can be operated by a foot pedal. The height of the harmonica can be adjusted precisely with the harmonica stand assembly of the invention.

In one embodiment, the harmonica stand assembly comprises: a) an elongated, upright microphone stand having an upper section and a lower section, wherein a microphone is removably attached to the upper section; b) a frame having an upper portion and a lower portion, wherein a harmonica holder is positioned in the upper portion and a foot pedal is positioned in the lower portion, the foot pedal having forward and rear portions, wherein the rear portion is pivotally fastened to a base platform of the frame and the forward portion is fastened to an actuator rod; and c) an extension spring having a first end attached to a spring attachment bracket, the spring attachment bracket being attached to the microphone stand, and a second end attached to the foot pedal; so that as the foot pedal is pressed downwardly, the actuator rod causes the harmonica holder to rotate and extend upwardly so that the harmonica holder and microphone are at the same height.

In one preferred embodiment, the front portion of the pedal further comprises a cut-out portion, and the microphone stand extends through the cut-out portion. Also, the extension spring preferably has a first hook at one end for attaching the spring to the spring attachment bracket, and a second end having a second hook for attaching the spring to the foot pedal.

The harmonica holder preferably comprises a first elongated arm containing a notch for receiving one end of a harmonica, and a second elongated arm containing a notch for receiving a second end of a harmonica. The first and second elongated arms of the harmonica holder can be fastened together by a first connecting member located in a front portion of the holder and by a second connecting member located in a rear portion of the holder.

A third connecting member is positioned between the first and second connecting members. In one preferred embodiment, the third connecting member is a U-shaped bracket having a first vertically-extending arm segment and second vertically-extending arm segment that are joined together by a horizontally extending cross-bar.

### BRIEF DESCRIPTION OF THE DRAWINGS

The novel features that are characteristic of the present invention are set forth in the appended claims. However, the preferred embodiments of the invention, together with further objects and attendant advantages, are best understood by reference to the following detailed description in connection with the accompanying drawings in which:

FIG. 1 is a perspective view of one embodiment of the harmonica stand assembly of the present invention;

FIG. 2 is a top-down view of the harmonica stand assembly shown in FIG. 1;

FIG. 3A is a perspective view of one embodiment of the harmonica stand assembly of the present invention showing a close-up of the harmonica holder and microphone in angled positions;

FIG. 3B is a perspective view of the harmonica stand assembly shown in FIG. 3A showing the foot pedal and base;

FIG. 4A is a perspective view of one embodiment of the harmonica stand assembly of the present invention showing a close-up the microphone in an angled position;

FIG. 4B is a perspective view of the harmonica stand assembly shown in FIG. 4A showing the foot pedal and base;

FIG. 5A is a perspective view of one embodiment of the harmonica stand assembly of the present invention showing a close-up of the harmonica holder, wherein the microphone fastened to the microphone stand;

FIG. 5B is a perspective view of the harmonica stand assembly shown in FIG. 5A showing the foot pedal and base;

FIG. 6A is a perspective view of one embodiment of the harmonica stand assembly of the present invention showing a close-up of the harmonica holder, wherein the microphone stand has not been fastened to the harmonica holder;

FIG. 6B is a perspective view of the harmonica stand assembly shown in FIG. 6A showing the foot pedal and base;

FIG. 7A is an exploded view of one embodiment of the foot pedal sub-assembly of the present invention; and

FIG. 7B is a perspective view of the foot pedal sub-assembly shown in FIG. 7A showing one embodiment of the harmonica stand assembly of the present invention.

### DETAILED DESCRIPTION OF THE INVENTION

The present invention relates generally to a harmonica stand assembly having an elongated, upright microphone stand; a frame having an upper portion and a lower portion, wherein a harmonica holder is positioned in the upper portion and a foot pedal is positioned in the lower portion; and an actuator system. The following description primarily refers to a harmonica stand assembly, but it should be understood that any suitable musical instrument can be used in accordance with the present invention. Referring to the Figures, one embodiment of a harmonica stand assembly of the present invention is shown.

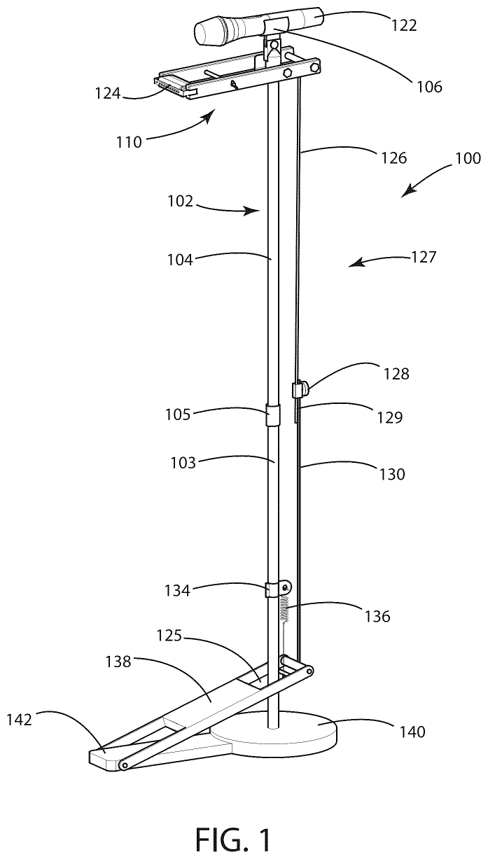

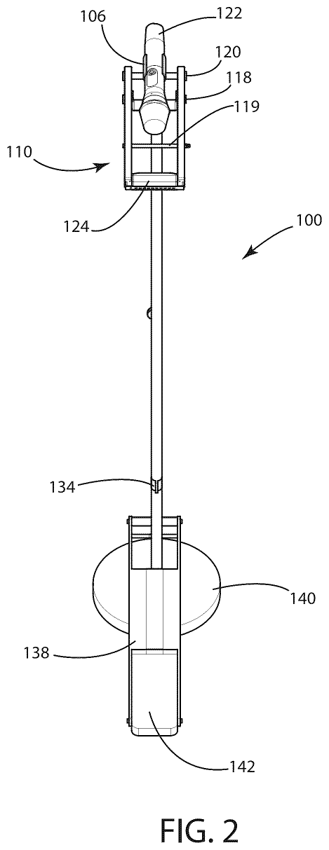

As shown in the Figures, the harmonica stand assembly (100) of the present invention includes a microphone stand (102). Microphone stands having telescopic sections can be used in accordance with the invention. For example, the microphone stand (102) can comprise a tubular lower section (103) and a tubular upper section (104), wherein the upper section (104) is telescopically slidable within the lower section (103). The upper section (104), when unlocked, can move freely upwardly and downwardly. When the upper section (104) reaches the desired height, the lower and upper sections (103,104) can be locked in place. An interlocking ring (105) can be used to lock the lower and upper sections (103, 104). The interlocked tubular lower and upper sections (103, 104) are mounted to a microphone stand base (140) as shown in FIGS. 1 and 2. A microphone (122) can be removably attached to the upper section (104). In one embodiment, the upper section (104) includes a microphone cradle (106) mounted at its top end, wherein the microphone (122) can be seated. A microphone stand having a single pole with telescopic sections, as described above, is one example of a stand that can be used in accordance with the present invention. It is recognized that other microphone stands, for example, boom-style microphone stands, can also be used.

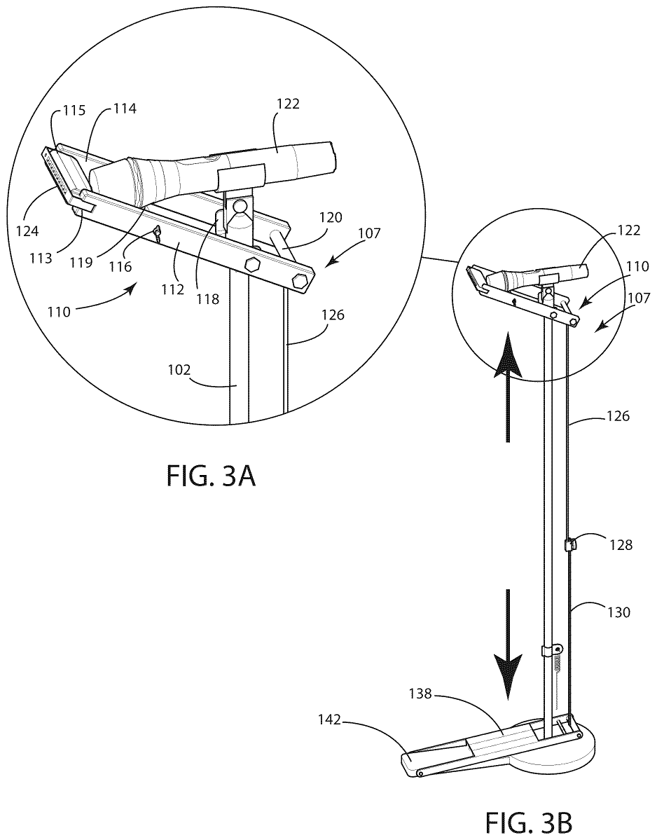

Referring to FIGS. 3A and 3B, the harmonica stand assembly (100) further includes an assembly frame generally indicated at (107) having an upper portion and a lower portion. A harmonica holder (110) is positioned in the upper portion, and a foot pedal (138) is positioned in the lower portion as discussed further below. The harmonica holder (110) comprises a first elongated arm (112) containing a first notch (113) for receiving one end of a harmonica (124). The harmonica holder (110) further comprises a second elongated arm (114) in parallel to the first elongated arm (112). The second elongated arm (114) contains a second notch (115) for receiving a second end of a harmonica (124) as described below. In the Figures, the harmonica holder (100) is shown as having one set of elongated arms (112, 114) for holding a single harmonica (124). However, it is recognized that the harmonica holder (124) can be modified to comprise a bracket for retaining multiple harmonicas.

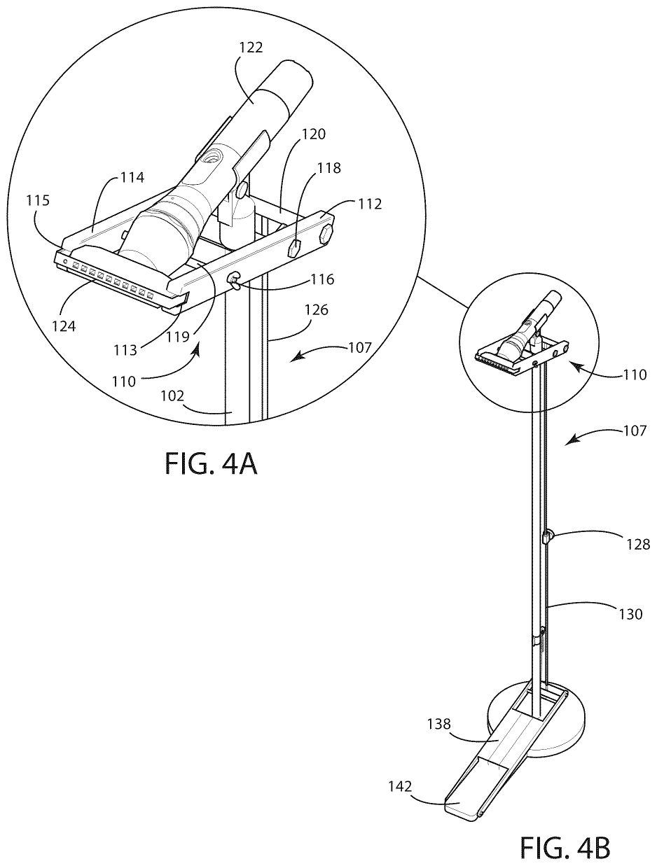

Referring to FIGS. 4A and 4B, the first and second elongated arms (112, 114) of the harmonica holder (110) are fastened together by a first connecting member (119) located in the front portion of the holder (110) and by a second connecting member (120) located in the rear portion of the holder (110). The first and second connecting members (119, 120) can comprise a bolt, rod, or other suitable fastener. For example, the connecting member (119, 120) can be a bolt having screw threads that will engage the screw threads of a wing nut (116). As shown in the Figures, when the wing nut (116) is tightened against the arm (112), the connecting member (119) is fastened into the holder (110).

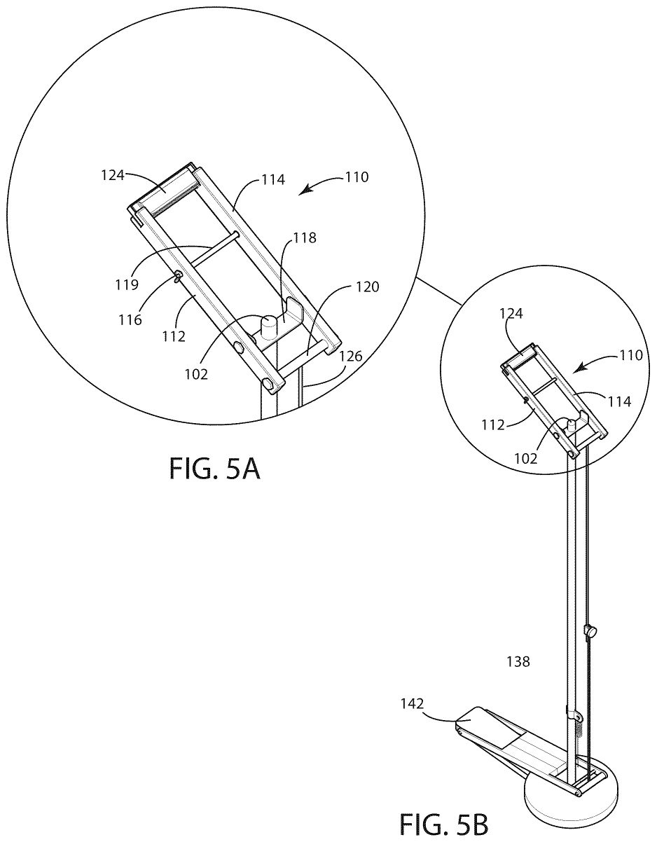

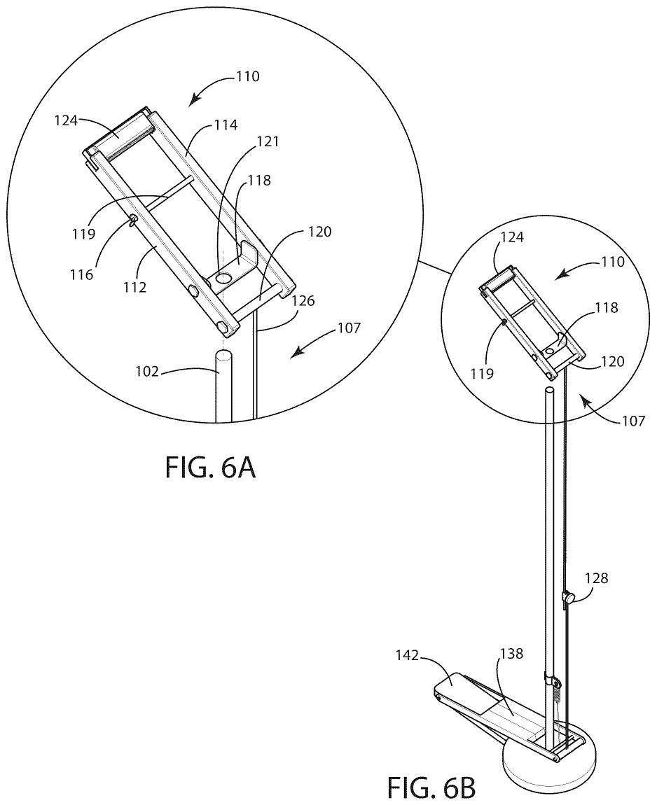

In FIGS. 5A-5B and 6A-6B, a third connecting member (118) is shown positioned between the first (119) and second (120) connecting members and is located in an intermediate portion of the harmonica holder (110). The third connecting member (118) can also comprise any suitable fastener. Preferably, the third connecting member (118) is a U-shaped bracket having a first vertical segment fastened to the first arm (112) of the harmonica holder (110), and a second vertical segment fastened to the second arm (114) of the harmonica holder (110). The U-shaped bracket further includes a horizontal cross-bar segment. The cross-bar segment has an opening (121) for the upper section of the microphone stand (102) to extend through. In FIGS. 5A and 5B, the upper section of the microphone stand (102) is shown extending through the opening (121). In FIGS. 6A and 6B, the upper section of the microphone stand (102) is shown positioned below the opening (121).

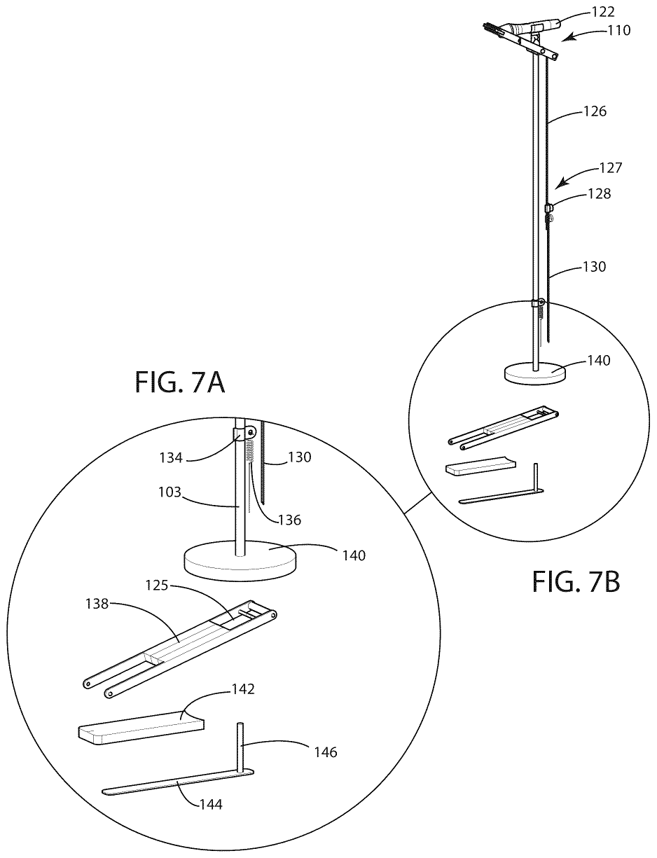

The harmonica stand assembly (100) further comprises a foot pedal (138) having forward and rear portions. The rear portion is pivotally fastened to a base platform (142) of the frame and the forward portion is fastened to an actuator rod sub-assembly (123) as described further below. Referring to FIGS. 7A and 7B, the front portion of the foot pedal (138) includes a cut-out portion (125), and the microphone stand (102) extends vertically through this cut-out portion (125).

As shown in FIGS. 7A and 7B, the base platform (142) of the assembly frame (107) preferably includes an extension segment (144) that runs under the base of the microphone stand (140). A key feature of the present invention is a vertically-extending retaining pin (146) that is mounted to the extension segment (144). The base platform (142) and lower section of the microphone stand (102) include a bore extending vertically therethrough. The vertical retaining pin (146) is inserted into the bore to fasten the base platform (142) to the microphone stand (102). Thus, the assembly frame (107) includes a unique reinforcing “right triangular-like” structural effect. The base platform (142) including the extension segment (144) acts as the base of the triangle. The base platform (142) and lower section of the microphone stand (102) containing the vertical retaining pin (146) act as the vertical leg of the triangle. Lastly, the foot pedal (138) acts as the hypotenuse of the triangle. The “right triangular-like” structural effect provides excellent dimensional-stability and support to the harmonica stand assembly (100) of the present invention. The harmonica stand assembly (100) is highly stable and remains standing during use. The harmonica stand assembly (100) has good mechanical strength and balance and is durable. The foot pedal (138) has a fulcrum point so that as a harmonica player engages the foot pedal and leans into the harmonic stand assembly (100) driving and playing the harmonica hard, the assembly (100) remains upright and does not topple over. In contrast, conventional harmonica stands tend to have poor stability. When a harmonica player plays the harmonica and leans into a conventional harmonica stand, the stand tends to have poor balance and can easily tip over.

As further shown in the Figures, the lower section (103) of the microphone stand (102) also includes a spring attachment bracket (134). An extension spring (136) having a first hook at one end for attaching the spring (136) to the spring attachment bracket (134) and a second end having a second hook for attaching the spring (136) to the foot pedal (134) can be used. In practice, when a person presses downward on the foot pedal (134), the extension spring (136) is stretched apart from its original position. The foot pedal (138) moves away from the spring attachment bracket (136) and downwards toward the floor surface.

As discussed above, the harmonica stand assembly (100) includes a foot pedal (138) and actuator rod (127). The foot pedal (138) is fastened to the lower portion of the actuator rod (127). The upper portion of the actuator rod (127) is fastened to the harmonica holder (110).

When the foot pedal (138) is pressed downwardly, it causes the actuator rod (127) to move downwardly. This causes the actuator rod (127) to impart an upward force on the harmonica holder (110), and the holder rotates and extends upwardly. In this way, the harmonica holder (110) can be adjusted to the same height as the microphone (122). In other embodiments, the harmonica holder (110) can be adjusted to a position above or below the microphone (122). The harmonica stand assembly (100) of the present invention can precisely set the harmonica holder (110) to any desired position. The actuator rod (127) biases the harmonic holder (110) upwardly when the foot pedal (138) is pressed downwardly. There is a downward force imparted to the foot pedal (138), and the actuator rod (127) supports the harmonica holder (110) in this rotated, upward position.

In turn, when a person lifts their foot from the foot pedal (138), it causes the actuator rod (127) to move upwardly. This causes the actuator rod (127) to impart a downward force to the harmonica holder (110), and the holder rotates downwardly and back to its starting position.

Turning back to FIG. 1, in one embodiment, there are two (2) actuator rods (126, 130). A first actuator rod (130) includes a lower portion that is fastened to the foot pedal (138), and an upper portion that extends through a clamp (128) having a bore. When the clamp (128) is tightened, the first actuator rod (130) is held in position as shown in the Figures. A second actuator rod (126) includes a lower portion that extends through a second clamp (129) having a second bore. The second actuator rod (126) includes an upper portion that is fastened to the harmonica holder (110). When the second clamp (129) is tightened, the second actuator rod (126) is held in position as shown in the Figures. In other embodiments, a single clamp can be used to hold the first and second actuator rods (126, 130). Any suitable actuating mechanism can be used in accordance with the invention. For example, in other embodiments, cables can be used with the foot pedal (138) to control the position of the harmonica holder (110).

As discussed above, in one embodiment, the microphone stand (102) is mounted on the base (140), and the foot pedal (138) is pivotally fastened to the base platform (142) have extension segment (144). It is recognized that the harmonica stand assembly can include other suitable base platforms in accordance with the invention. The base platform can have any desirable size and shape and other sections for mounting additional musical equipment and accessories that can be played along with the harmonica. For example, the base platform can be used for mounting guitars and various pedals such as guitar pedals, distortion pedals, accessory pedals, vocal pedals, and stomp boxes. In one embodiment, a rectangular-shaped base platform having strips of Velcro® fasteners attached to the surface of the base platform is used for mounting other musical equipment and accessories.

The height-adjustable harmonica stand assembly of the present invention provides many advantages. For example, the harmonica stand assembly is lightweight and yet durable. The harmonica stand assembly is portable, and a harmonica player can easily handle and use the assembly. The harmonica stand assembly allows the harmonica player to be hands-free so he/she are more comfortable and can play another instrument such as, for example, a guitar or piano. Furthermore, the unique height-adjustable features of the present invention allow the harmonica player to move the harmonica to a precisely desired position. Particularly, the harmonica player can move the harmonica so that it is adjacent to and sits at the same height as the microphone. In this manner, the harmonica player can play the harmonica with improved sound and acoustics.

It should be understood that the terms, “first”, “second”, “top”, “bottom”, “upper”, “lower”, “upwardly”, “downwardly”, “above” “below”, “right”, “left”, and the like are arbitrary terms used to refer to one position of an element based on one perspective and should not be construed as limiting the scope of the invention.

It also should be understood that the assemblies, sub-assemblies, materials, constructions, and the like described and illustrated herein represent only some embodiments of the invention. It is appreciated by those skilled in the art that various changes and additions can be made to the assemblies, sub-assemblies, materials, and constructions and the like without departing from the spirit and scope of this invention. It is intended that all such embodiments be covered by the appended claims.

I claim:

1. A harmonica stand assembly, comprising;
an elongated, upright microphone stand having an upper section and a lower section, wherein a microphone is removably attached to the upper section;
a frame having an upper portion and a lower portion, wherein a harmonica holder is positioned in the upper portion and a foot pedal is positioned in the lower portion, the foot pedal having forward and rear portions, wherein the rear portion is pivotally fastened to a base platform of the frame and the forward portion is fastened to an actuator rod;
an extension spring having a first end attached to a spring attachment bracket, the spring attachment bracket being attached to the microphone stand, and a second end attached to the foot pedal; so that as the foot pedal is pressed downwardly, the actuator rod causes the harmonica holder to rotate and extend upwardly.

2. The harmonica stand assembly of claim 1, wherein the actuator rod causes the harmonica holder to rotate and extend upwardly so that the harmonica holder and microphone are at the same height.

3. The harmonica stand assembly of claim 1, wherein the harmonica holder comprises a first elongated arm containing a notch for receiving one end of a harmonica, and a second elongated arm containing a notch for receiving a second end of a harmonica.

4. The harmonica stand assembly of claim 3, wherein the first and second elongated arms of the harmonica holder are fastened together by a first connecting member located in a front portion of the holder and by a second connecting member located in a rear portion of the holder.

5. The harmonica stand assembly of claim 4, wherein a third connecting member is positioned between the first and second connecting members.

6. The harmonica stand assembly of claim 4, wherein the third connecting member is a U-shaped bracket having a first vertically-extending arm segment and second vertically-extending arm segment that are joined together by a horizontally extending cross-bar.

7. The harmonica stand assembly of claim 5, wherein the cross-bar of the U-shaped bracket comprises an opening, and the upper section of the microphone stand extends through the opening.

8. The harmonica stand assembly of claim 1, wherein the front portion of the pedal further comprises a cut-out portion, and the microphone stand extends through the cut-out portion.

9. The harmonica stand assembly of claim 1, wherein the extension spring has a first hook at one end for attaching the spring to the spring attachment bracket, and a second end having a second hook for attaching the spring to the foot pedal.

10. The harmonica stand assembly of claim 1, wherein the wherein the actuator rod causes the harmonica holder to rotate and extend upwardly so that the harmonica holder and microphone are positioned above or below the microphone.
